(19) United States
(12) Patent Application Publication
(10) Pub. No.: US 2018/0241927 A1
(43) Pub. Date: Aug. 23, 2018

(54) Exposure Metering Based On Depth Map

(71) Applicant: Motorola Mobility LLC, Chicago, IL (US)

(72) Inventors: YinHu Chen, Deerfield, IL (US); Susan Yanqing Xu, Westmont, IL (US); Valeriy Marchevsky, Glenview, IL (US)

(73) Assignee: Motorola Mobility LLC, Chicago, IL (US)

(21) Appl. No.: 15/441,085

(22) Filed: Feb. 23, 2017

(51) Int. Cl. H04N 5/235; G06K 9/62; G06K 9/46; G06K 9/52; G01C 3/08; H04N 13/02; G06K 9/54

(52) U.S. Cl. CPC H04N 5/2351; G06K 9/6267; G06K 9/4671; G06K 9/6215; G06K 2009/4666; G01C 3/08; H04N 13/0271; H04N 13/0239; G06K 9/54; G06K 9/52

(57) ABSTRACT

Various embodiments provide dynamic adjustments to exposure metering used in digital image capture based upon a depth map. A computing device includes at least two image sensors that are synchronized to capture an image or frame of a scene at a same time. Some embodiments, prior to creating a digital image capture, generate a depth map based upon a current frame of a scene that is in view of the image sensors. In turn, the computing device generates weighting values based upon the depth map, and calculates a current frame luma based upon these weighting values. The computing device then calculates settings to adjust exposure metering based upon the current frame luma to improve the digital image capture relative to a digital image capture with fixed exposure metering.

### BACKGROUND

Cameras capture a scene in the real-world as a static image or video by exposing various capture mechanisms to light. An analog camera captures the scene using analog means, such as a filmstrip, and a digital camera captures the scene using sensors that translate the scene into a digital representation. To facilitate how well the capture mechanisms replicate the scene, a camera regulates how and when to expose the capture mechanisms to light, also referred to as exposure metering. An automatic exposure control (AEC) mechanism automates adjustments to exposure metering that, in turn, affects how well the static image recreates the scene. However, these automated adjustments are using fixed exposure metering which can lead to faulty exposure settings since the fixed exposure metering does not always properly account for the luminance of a scene in its entirety. Thus, it is desirable to have a way to dynamically determine how to adjust exposure settings based upon the various objects in and/or luminance of a scene.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an overview of a representative environment that includes an example implementation in accordance with one or more embodiments;

FIG. 2 illustrates a more detailed view of an example implementation included in FIG. 1 in accordance with one or more embodiments;

FIG. 3 illustrates an example of digitally capturing scene in accordance with one or more embodiments;

FIG. 4 illustrates an example of a digital image sensor in accordance with one or more embodiments;

FIG. 5 illustrates example fixed weighting tables that can be employed in accordance with one or more embodiments;

FIG. 6 illustrates an example depth map based upon a current frame from image sensors in accordance with one or more embodiments;

FIG. 7 illustrates an example of a dynamically generated weighting table based upon a depth map in accordance with one or more embodiments;

FIG. 8 illustrates a flow diagram in which dynamic exposure metering is employed in accordance with one or more embodiments;

FIG. 9 illustrates example images captured in during a test case in accordance with one or more embodiments; and

FIG. 10 is an illustration of an example device in accordance with one or more embodiments.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Various embodiments provide dynamic adjustments to exposure metering used in digital image capture based upon a depth map. A computing device includes at least two image sensors that are synchronized to capture an image or frame of a scene at a same time. Some embodiments, prior to creating a digital image capture, generate a depth map based upon a current frame of a scene that is in view of the image sensors. In turn, the computing device generates weighting values based upon the depth map, and calculates a current frame luma based upon these weighting values. The computing device then calculates settings to adjust exposure metering based upon the current frame luma to improve the digital image capture relative to a digital image capture with fixed exposure metering.

Consider now an example environment in which various aspects as described herein can be employed.

Example Environment

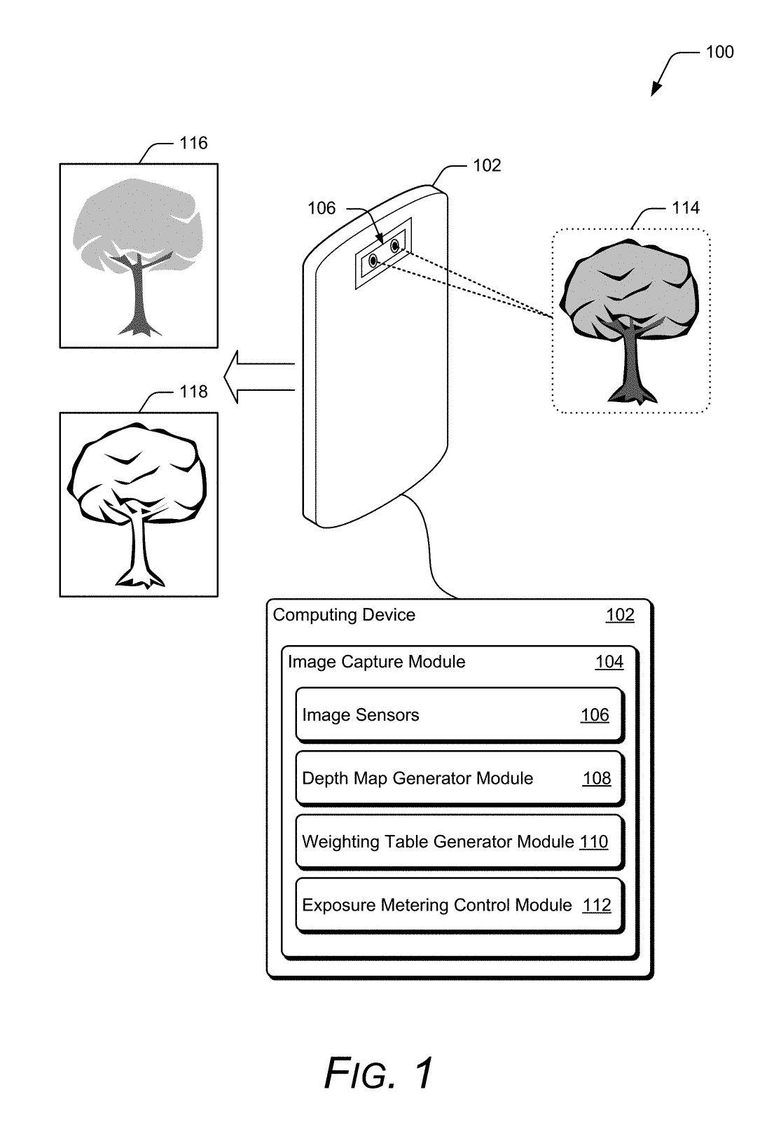

FIG. 1 illustrates an example operating environment 100 in accordance with one or more embodiments. Environment 100 includes computing device 102 in the form of a mobile phone. However, it is to be appreciated that computing device 102 can be any other suitable type of computing device without departing from the scope of the claimed subject matter. Among other things, a user can interact with computing device 102 to capture digital images and/or video of various scenes. In this example, computing device 102 includes an image capture module 104, which represents functionality that automatically configures various image capture mechanisms based upon a depth map as further described herein. For discussion purposes, image capture module 104 is illustrated as a single module, but it is to be appreciated that image capture module 104 can be implemented using any suitable combination of hardware, software, and/or firmware.

Image capture module includes image sensors 106 that work together in concert to generate a digital image. For example, image sensors 106 include two image sensors that capture respective images. In some cases, each respective image sensor is designed to capture different information, such as color image information, clear or shading image information, raw image data, and so forth. In other cases, the image sensors each capture a respective image in a same format and/or with the same information, but from a different perspective. Images can be stored in various color spaces and representations, such as Red-Green-Blue (RGB), standard Red-Green-Blue (sRGB), Luminance-Blue-Luminance-Red-Luminance (YUV), a color-opponent space with Lightness and color-opponent dimensions (CIE L*a*b), and so forth. These images can also be stored or expressed in any suitable format, such as Joint Photographic Experts Group (JPEG), Tagged Image File Format (TIFF), Graphics Interchange Format (GIF), bitmap (BMP), Portable Network Graphics (PNG), High-Dynamic-Range Imaging (HDRI), and so forth. These sensors can have various resolutions and be of any suitable types as further described herein. Here, the term “image sensor” generally represents a sensor that is used to capture a corresponding image, and can be a single sensor, or multiple smaller sensors that work together to generate a single image.

Image capture module 104 also includes depth map generator module 108, weighting table generator module 110, and exposure metering control module 112. Among other things, depth map generator module 108 represents functionality that generates relational information about objects in a scene, such as a depth map. To do so, some embodiments of depth map generator module 108 use image information about a scene captured or currently in view of image sensors 106 to generate the relational information about various objects and/locations positioned in scene 114. For example, depth map generator module 108 can use digital image 116 and digital image 118 to generate a depth map. However, other types of information can be used to generate a depth map, such as frame information that generates statistics about a scene in view of the image sensors.

Weighting table generator module 110 represents functionality that dynamically generates a weighting table associated with calculating a frame luma that can be used to adjust exposure settings used by image capture module 104 (e.g., exposure time settings, luminance gain settings). Among other things, a frame luma represents a metric that indicates the luminance or brightness of a scene as seen by image sensors. Weighting table generator module 110 can generate a single weighting table that is used to adjust exposure settings for image capture module 104 as a whole, or generate multiple weighting tables, where each respective weighting table corresponds with a respective image sensor. In some cases, the dynamic generation of a weighting table is based on relational information and/or a depth map generated by depth map generator module 108. A weighting table can be any suitable size, include any suitable number of grid elements, and/or include any suitable weighting values, examples of which are provided herein.

Exposure metering control module 112 represents functionality that automatically adjusts exposure settings used by image sensors 106 and/or image capture module 104, such as exposure time settings and/or luminance gain settings. In some embodiments, exposure metering control module 112 uses the weighting table generated by weighting table generator module 110 to calculate a current frame luma for a current frame or scene in view of image sensors 106. Calculating the current frame luma can include applying weighting information in the weighting table to statistical information generated by image sensors 106. Upon calculating a current frame luma, exposure metering control module 112 adjusts the exposure settings for one or all of image sensors 106.

Environment 100 includes a scene 114 that generally represents any suitable viewpoint or object that an image capture module can visually capture. In this example, each respective image sensor of image sensors 106 captures a respective image that relates to scene 114 such that a first image sensor captures digital image 116 and a second image sensor captures digital image 118. In this example, digital image 116 and digital image 118 are illustrated as capturing different types of information about scene 114, but in alternate embodiments, digital image 116 and digital image 118 capture the same information. When considered together, these dual images can be considered a frame or a captured image of scene 114.

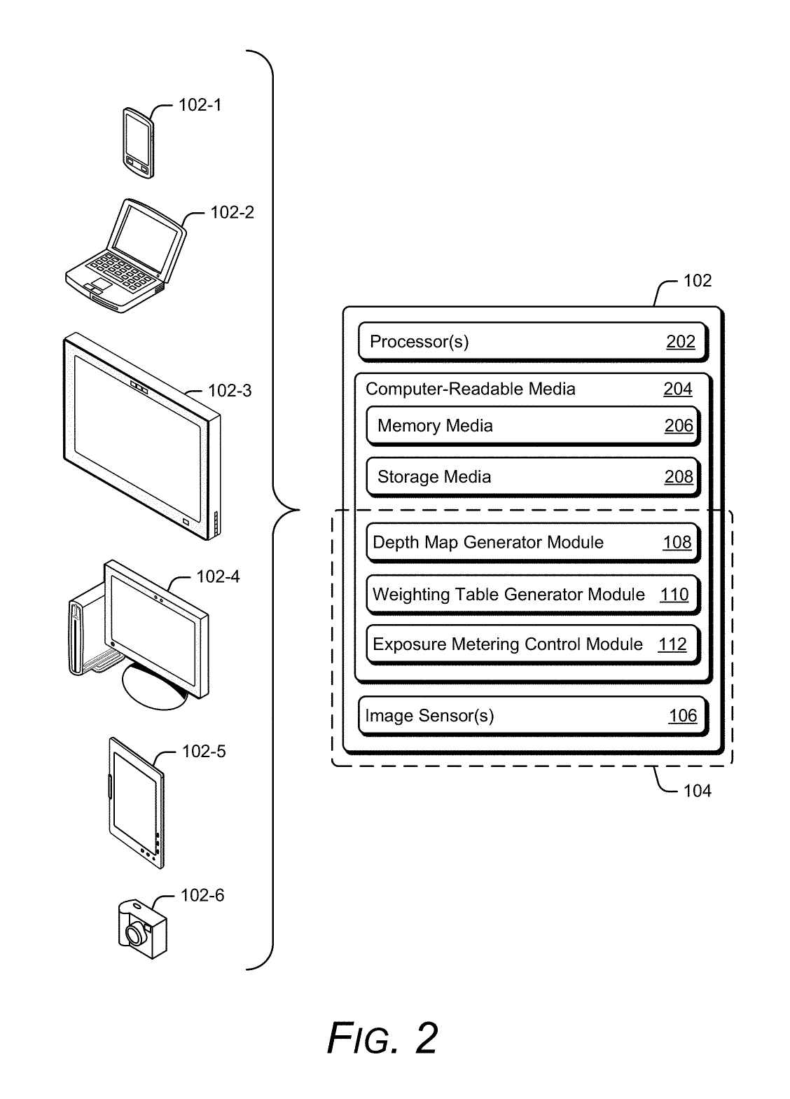

FIG. 2 illustrates an expanded view of computing device 102 of FIG. 1 with various non-limiting example devices including: smartphone 102-1, laptop 102-2, television 102-3, desktop 102-4, tablet 102-5, and camera 102-6. Accordingly, computing device 102 is representative of any suitable device that incorporates digital image capture and processing capabilities by way of image capture module 104. Computing device 102 includes processor(s) 202 and computer-readable media 204, which includes memory media 206 and storage media 208. Applications and/or an operating system (not shown) embodied as computer-readable instructions on computer-readable media 204 can be executed by processor(s) 202 to provide some or all of the functionalities described herein. To facilitate image capture, computing device 102 includes image capture module 104. Here, portions of image capture module 104 are stored on computer-readable media 204: depth map generator module 108, weighting table generator module 110, and exposure metering control module 112. However, while depth map generator module 108, weighting table generator module 110, and exposure metering control module 112 are illustrated here as residing on computer-readable media 204, they each can alternately or additionally be implemented using hardware, firmware, or any combination thereof. Image capture module 104 also includes image sensors 106, which can be one or multiple image capture mechanisms.

Having described an example operating environment in which various embodiments can be utilized, consider now a discussion of digital image captures in accordance with one or more embodiments.

Digital Image Captures

Image capture mechanisms preserve an image based upon their exposure to light. An analog camera exposes a filmstrip as a way to detect or capture light. Light alters the filmstrip and, in turn, the image can be recovered by chemically processing the filmstrip. In an analog image capture, the filmstrip stores a continuous representation of the light (and corresponding scene). Digital image sensors, too, are exposed to light to capture information. However, instead of an analog representation, digital image sensors generate and store discrete representations of the image.

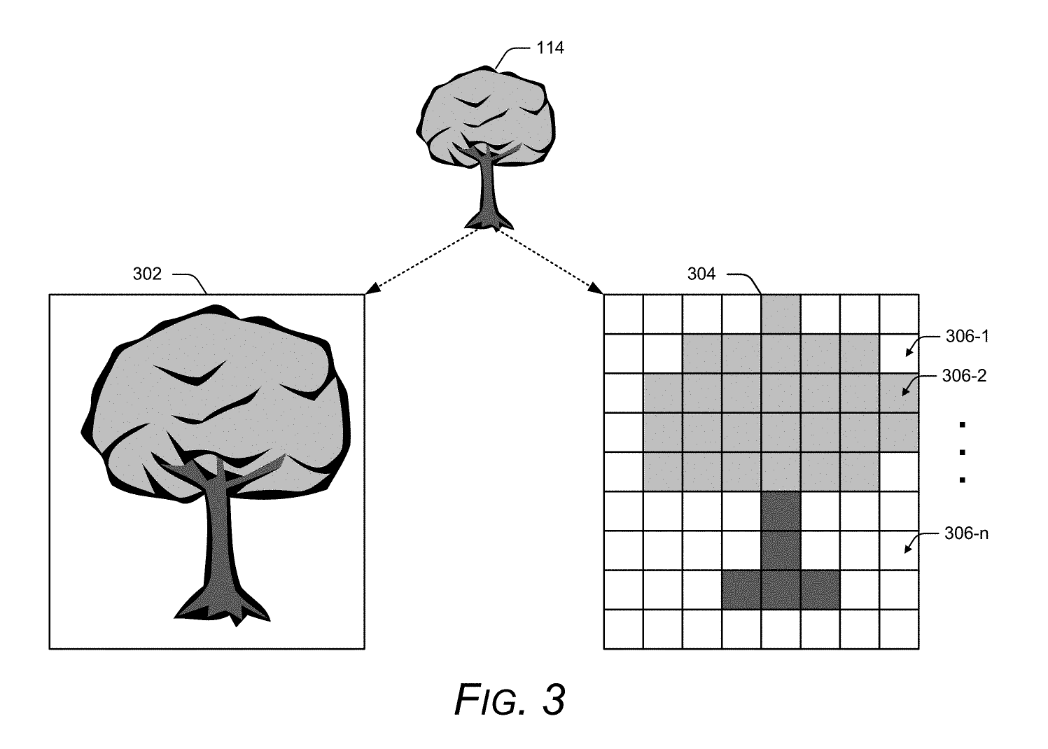

Consider FIG. 3 in which alternate image capture mechanisms are employed to capture scene 114 of FIG. 1. Image 302 illustrates an analog capture of scene 114 performed through the use of analog techniques, such as film capture. Here, the image has been captured in a continuous nature. Conversely, image 304 illustrates a digital capture of scene 114. Instead of capturing the image continuously, image 304 represents sectors of scene 114 in discrete components, alternately known as a pixel. Each discrete component has a value associated with it to describe a corresponding portion of the image being captured. For example, discrete component 306-1 represents a region of scene 114 in which the tree is not present, discrete component 306-2 represents a region of scene 114 in which a portion of the tree is present, and so forth. Accordingly, image 304 digitally represents scene 114 by partitioning the image into “n” discrete components (where “n” is an arbitrary value), and assigning a value to each component that is uniform across the whole component. Thus, discrete component 306-1 has a first value, discrete component 306-2 has a second value, and so forth all the way up to discrete component 306-n. Here, the term “value” is generally used to indicate any representation that can be used to describe an image. In some cases, the value may be a single number that represents an intensity or brightness of a corresponding light wave that is being captured. In other cases, the value may be a combination of numbers or vectors that correspond to various color combinations and/or intensities associated with each color.

The size of a discrete component within a digital image, as well as the number of discrete components, affects a corresponding resolution of the image. For example, image 304 is illustrated as having 9×8=72 discrete components. However, relative to the analog capture represented in image 302, it can be seen that there are inaccuracies in the digital image capture. Given the size of each discrete component, and the uniform nature across the whole of the discrete component, the resultant image lacks details that can be found either in image 302 or original scene 114. By increasing the number of components and reducing the size of the components, the resultant digital image can more accurately capture details and add resolution to the image to more closely resemble the analog version and/or the original captured image. A pixel refers to a singular discrete component of a digital image capture that is the smallest addressable element in the image. Thus, each pixel has a corresponding address and value.

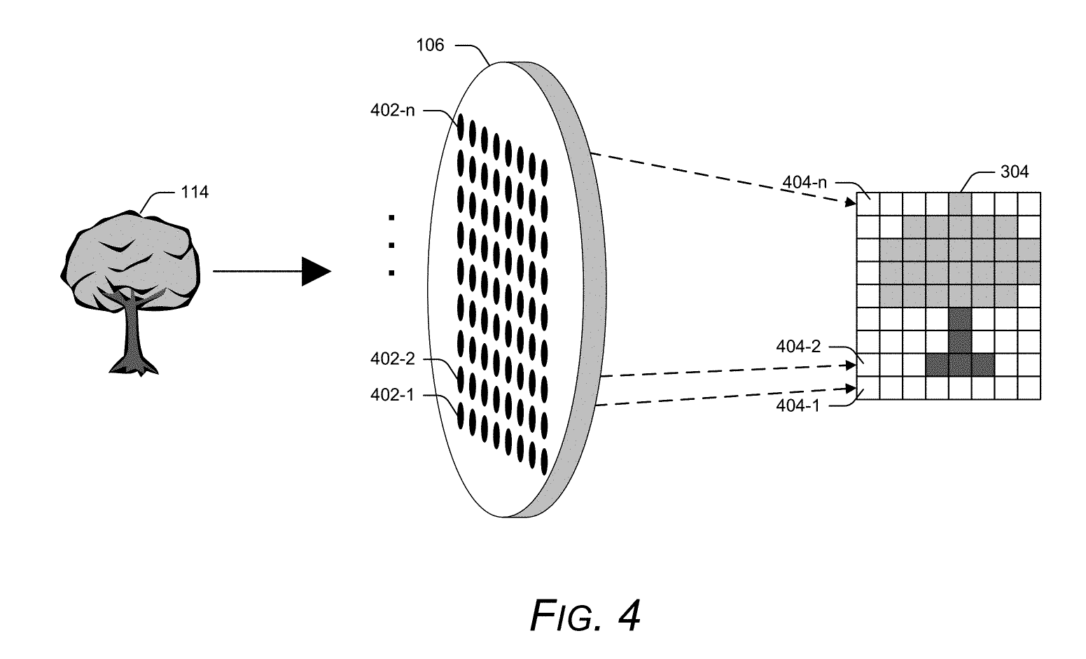

A singular image sensor, such as one of the image sensors in image sensors 106 of FIG. 1, can consist of several smaller sensors. Consider FIG. 4 that includes an example of image sensor 106 from FIG. 1, scene 114 from FIG. 1, and image 304 from FIG. 3. As can be seen, image sensor 106 includes multiple smaller sensors, labeled as sensor 402-1 through sensor 402-n, where n is an arbitrary number. For simplification, these sensors will be generally referred to as sensors 402 when discussed collectively. While this example illustrates image sensor 106 as having 72 small sensors, an image sensor can have any suitable number of sensors without departing from the scope of the claimed subject matter. Each sensor of sensors 402 can relate to a grid of colors (e.g., red, blue, or green), a grid of luminance, a single pixel, multiple pixels, or any combination thereof. For example, sensor 402-1 corresponds to data captured to generate pixel 404-1, sensor 402-2 corresponds to data captured to generate pixel 404-2, and sensor 402-n corresponds to data captured to generate pixel 404-n. While illustrated as a single entity, it is to be appreciated that sensors 402 can each be considered a sensor unit, in which the unit includes multiple sensors with varying functionality. Through careful selection and arrangement, the different smaller (color) sensors can improve the resultant image capture. A Bayer array (alternately referred to here as a Bayer filter or Bayer grid) is one particular arrangement where 50% of the sensors are associated with green, 25% are associated with red, and 25% are associated with blue. In other words, a general RGB image sensor used to capture an image may utilize multiple smaller green image sensors, multiple smaller blue image sensors, and multiple smaller red image sensors to make up the overall general RGB image sensor. These smaller sensors capture characteristics about the incoming light with respect to colors, as well as intensity. In turn, the values stored for each discrete representation of an image captured using Bayer filter techniques each express the captured color characteristics. Thus, image 304 has multiple discrete components that each correspond to a respective value (or values) that represent as a Bayer image capture. While the above discussion refers to RGB, it is to be appreciated that other color combinations can be used without departing from the scope of the claimed subject matter. Two such types of information that are extractable from a Bayer image capture are luma channel data and chroma channel data (alternately referred to here as luma channel information and chroma channel information).

Luma channel information refers to brightness or intensity related to a captured image. For instance, an image or pixel with little to no brightness (e.g., dark or black) would have generally 0% luminance or brightness, while an image or pixel that is has a large amount of light has generally 100% luminance (e.g., bright or white). Depending upon the brightness or intensity, luma information over an image can vary over a range of 0%-100%. Instead of tracking color information, luma information captures light intensity, and can alternately be considered in some manner as a greyscale representation of an image. When a camera captures an image, the intensity or brightness captured in an image can sometimes be controlled through AEC.

These examples are for discussion purposes, and are not intended to be limiting. Further, it is to be appreciated that the technical aspects of digital image capture have been simplified, and is not intended to describe all aspects of digital image capture, Bayer grids, other color formats or filters, and so forth. Having described various principles associated with digital image capture, now consider a discussion of fixed automatic exposure control.

Fixed Automatic Exposure Control

AEC automatically configures exposure metering in an image sensor to achieve a desired brightness or luma value for a particular capture. For example, in scenes that have low lighting, the AEC may adjust exposure time settings and/or luminance gain settings for various sensors to be more sensitive to, or emphasize, the brightness and/or luma, while in scenes that have bright lighting, the AEC may adjust the exposure settings to be less sensitive to, or deemphasize, the brightness. These adjustments help to achieve proper exposure for the scene when the camera captures it, so that the resultant static image more accurately represents the scene than with no adjustments. In some cases, a computing device and/or camera can use a preview or viewfinder function to analyze a scene in order to determine how to configure the AEC. For instance, a preview function can scan a current scene within view of the image sensors (alternately referred to as a frame), and identify current illumination levels (e.g., a high illumination level having bright lighting, a low illumination level having low lighting). These illumination levels of the current scene can then be used determine how to adjust the sensors.

Exposure metering algorithms used by a camera calculate a current frame luma of the current scene or frame based upon statistics generated by the sensors, such as Bayer grid statistical information for a grid of pixels as further described herein. After calculating the current frame luma, the camera compares it to a predefined luma target and determines the difference between the current frame luma and the pre-defined luma target. This difference is the used to obtain exposure metering adjustment information (e.g., exposure time and/or luminance gain for the image sensors) by consulting a predefined sensor-specific exposure table. In turn, the camera then reconfigures the sensor hardware based upon the exposure time and gains to achieve a desired sensitivity to brightness by the sensors. When needed, the camera repeats this process until the current luma frame reaches the luma target, or is within an acceptable tolerance. Thus, AEC helps meter the exposure of light to a capture mechanism based on a current frame luma.

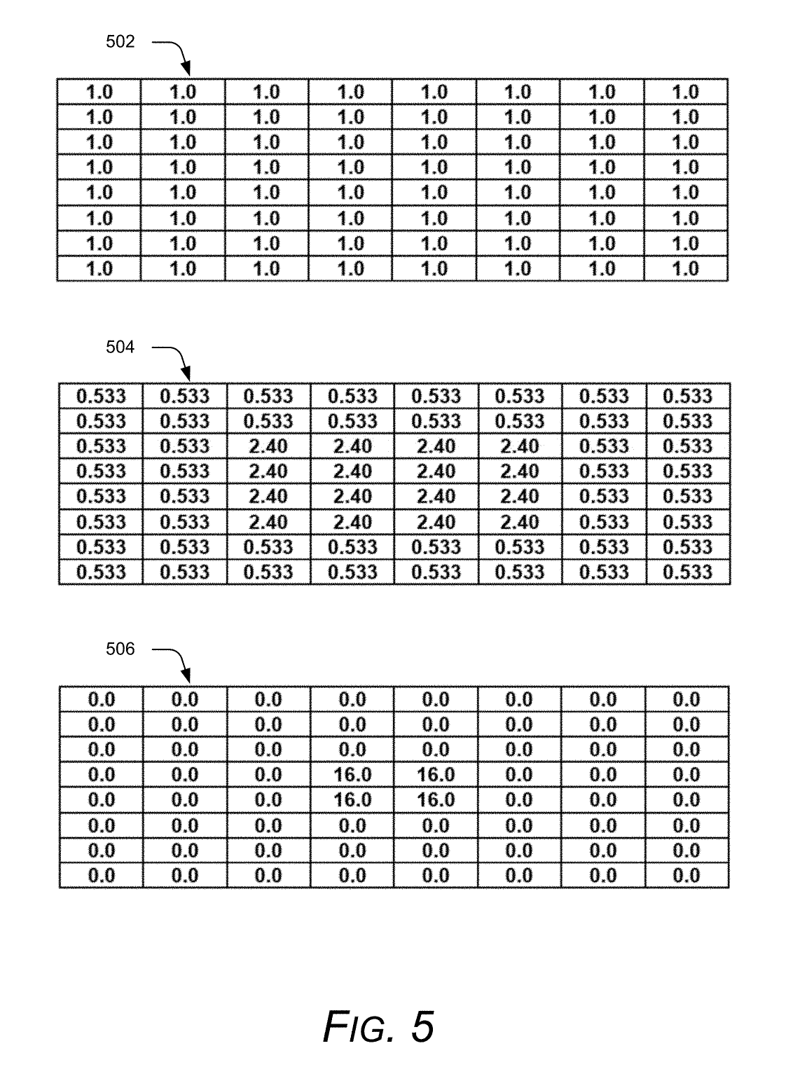

FIG. 5 illustrates three types of exposure metering used to weight a sensor grid when calculating a current frame luma. Table 502 illustrates an example of average-weighted exposure metering, table 504 illustrates an example of center-weighted exposure metering, and table 506 illustrates an example of spot-weighted exposure metering. For discussion purposes, each table is illustrated with 8×8=64 grid elements, but it is to be appreciated that a table can have any other suitable number of elements (e.g., 64×48, 128×128, and so forth). Each table corresponds to a grid of image capture sensors, where each element of the table pertains to a unit of image capture within a frame. Referring back to image sensor 106 as illustrated in FIG. 4, an element of the table can correspond to a single sensor (e.g., sensor 402-2, sensor 402-2, etc.) or an arbitrary combination of multiple sensors (e.g., a combination of sensor 402-1 with sensor 402-2, a combination of sensor 402-1 with sensor 402-2 and sensor 402-n, etc.), and so forth. In some cases, a grid element corresponds to a single pixel, while in other cases, a grid element can correspond to multiple pixels. For example, consider an image sensor that includes 10 Megapixels. When there is a large volume of pixels, it can be more efficient to group pixels into a grid element of the weighting table. For example, a weighting table grid element can be associated with a grid of 16×16 pixels, a grid of 64×84 pixels, a grid of 34×48 pixels, and so forth. In cases where a grid of pixels corresponds to a weighting table grid element, the statistics utilized in subsequent current frame luma calculations correspond to statistical information generated over that grouping of pixels (e.g., an average of luminance over the grid of pixels).

Table 502 illustrates an average-weighted frame. In this example, each element of the grid has a same weight of 1.0. When using the average-weighted exposure metering, the AEC algorithm equally weights the luma statistics generated by the image sensors for a current frame to calculate the current frame luma. Conversely, table 504 illustrates center-weighted exposure metering, where the AEC algorithm applies different weightings to the statistics generated by the image sensors for the current frame. When using center-weighted exposure metering, the center cluster of elements has a higher weighting (illustrated here as 2.40) relative to the outer perimeter of elements (illustrated here as 0.533). Thus, the AEC algorithm gives a center portion of an image more priority or weight in determining an exposure setting for a subsequent image capture. In other words, center-weighted exposure metering adjusts the camera's exposure settings to obtain proper exposure for the center of a scene in the subsequent image capture at the trade-off of degrading the exposure for the perimeter of the scene. While the resultant current frame luma results considers the perimeter elements of the scene, the corresponding statistics of the perimeter elements contribute less to the overall determination of the current frame luma, and thus the exposure metering applied by AEC. Now consider table 506, in which the perimeter elements and/or the statics generated by the corresponding sensors for a current frame have no weighting at all. As can be seen, the spot-weighted exposure metering of table 506 applies a weighting of 0 to the perimeter elements, and a weighting of 16 to the center elements, thus disregarding all statistics generated about the perimeter of the scene.

While table 502, table 504, and table 506 offer options to adjusting a camera's exposure metering, there are drawbacks. To begin, after product launch of a camera, these tables are fixed. For example, the values of the weighting given to the elements, as well as the designation of the areas for different weightings are predefined at product launch and stored on the camera. With respect to spot-weighted exposure metering, a camera can sometimes move the spot to a designated Region-of-Interest (ROI) based upon either a user specifying the ROI or an auto-focus feature identifying an ROI. However, even in the case of spot-weighted exposure metering in which the ROI moves, the ROI region remains fixed in size and shape (e.g., a fixed rectangle). In the real-world, not all objects follow the sizing or the shape of a pre-defined ROI region. These drawbacks associated with fixed AEC can lead to improper exposure metering for an image, thus negatively impacting the quality of a resultant image capture.

Having described various principles associated with fixed AEC, now consider a discussion of dynamic AEC adjustments in accordance with one or more embodiments.

Dynamic Automatic Exposure Control Based on Depth Map

Various embodiments provide dynamic adjustments to exposure metering of an image capture module and/or image capture device based upon a depth map. Image capture devices that include synchronized image sensors can capture multiple images of a scene and/or frame information at a same time. By having synchronized images and/or frame information, various embodiments generate depth and/or distance information for different objects within the scene that can then be used to dynamically modify exposure metering by modifying various exposure settings of the image sensors as further described herein.

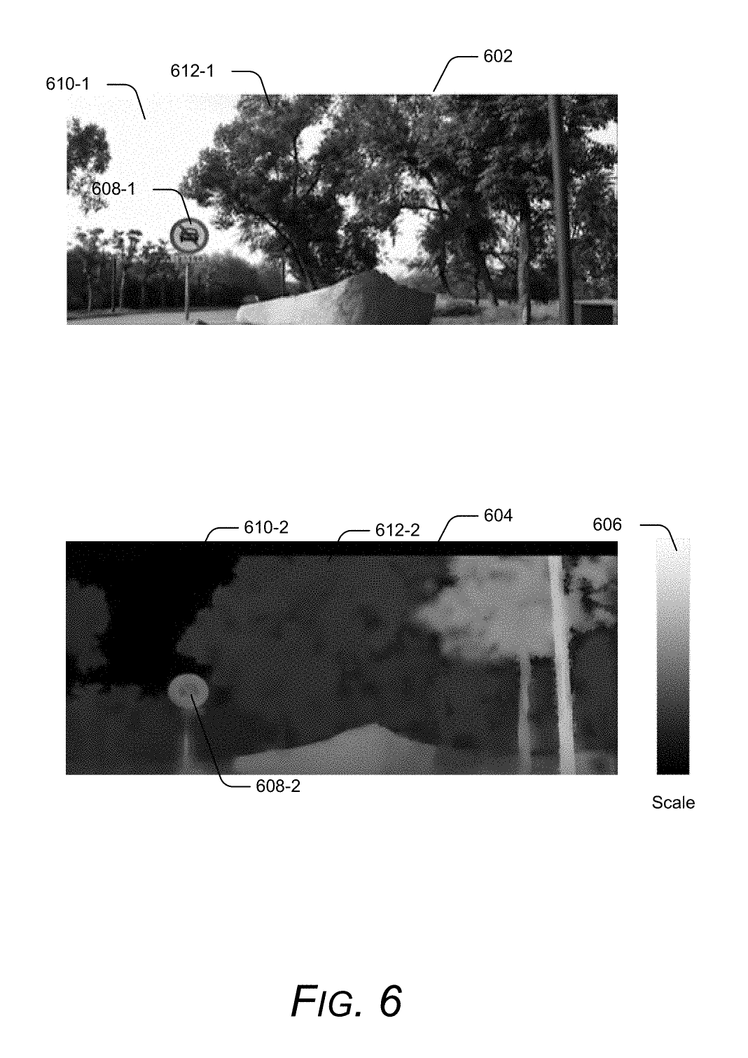

A depth map provides distance information for different objects or location within a scene. In some cases, this distance information represents the distance of an object from a particular viewpoint or frame of reference. However, this distance information can additionally include, or be used to extract, relational information between the different objects. To further illustrate, consider FIG. 6 that includes image 602 and depth map 604. Image 602 is an example current frame as seen by an image sensor. For simplicity's sake, image 602 is illustrated here as a single image, but can alternately or additionally represent two synchronized current frame images captured by dual sensors, such as image sensors 106 of FIG. 1. Among other things, two synchronized images or frames have sufficient information to discern depth information about objects or locations associated with the synchronized images.

To illustrate, consider a point “X” within a scene, where “X” is at an arbitrary distance from a camera (or other type of computing device) that includes two image sensors (also known as a dual camera). In capturing this scene (and “X”), the camera generates a first image and a second image using a first image sensor and a second image sensor, respectively. Since there are two images sensors, and they do not share a same physical space, the first image and the second image have differing views of the scene, where each viewpoint of the view derives itself from the positioning of the respective image sensor. In light of this, the first location of “X” in the first image differs from the second location of “X” in the second image. Generally, a depth of a point or object in a scene is inversely proportional to the difference in distance of the image points and their respective camera centers. In applying this to the dual image capture that includes “X”, the depth of “X” can be determined using knowledge of the first location of “X” relative to the center of the first image sensor, and the second location of “X” relative to the center of the second image sensor. In some cases, determining the depth of “X” alternately or additionally uses information pertaining to the relative positioning of the image sensors (e.g., the distance between a first image sensor and a second image sensor).

Here, depth map 604 corresponds to relational positioning and/or depth information of the various objects or locations associated with image 602. In depth map 604, an object or location with a darker hue corresponds to location that is further away from the image sensor than an object or location with a lighter hue. Scale 606 also illustrates this, where the top of the scale has a white hue and gradually transitions to a black hue at the bottom. The variation of shades that transition between the lightest hue on scale 606 to the darkest hue on scale 606 generally indicate the varying distances or depths in which objects reside in a scene. Thus, lighter hues correspond to depth distances closer to the image sensor (e.g., less depth), darker hues correspond to depth distances further from the image sensor (e.g., more depth or distance), and the various hues in between the lightest hue and the darkest hue correspond to depth distances in between the closest and furthest depths, respectively. As can be seen in image 602, sign 608-1 is positioned in the foreground of image 602, sky 610-1 is positioned in the background of image 602, and trees 612-1 are positioned intermediate and in between the foreground and background. In depth map 604 and relative to one another, sign 608-2 has the lightest hue, sky 610-2 has the darkest hue, and trees 612-2 have a hue that is in between the lightest hue and the darkest hue. For illustrative purposes, depth map 604 represents a visual representation of distance and/or depth information stored within the depth map using a greyscale image.

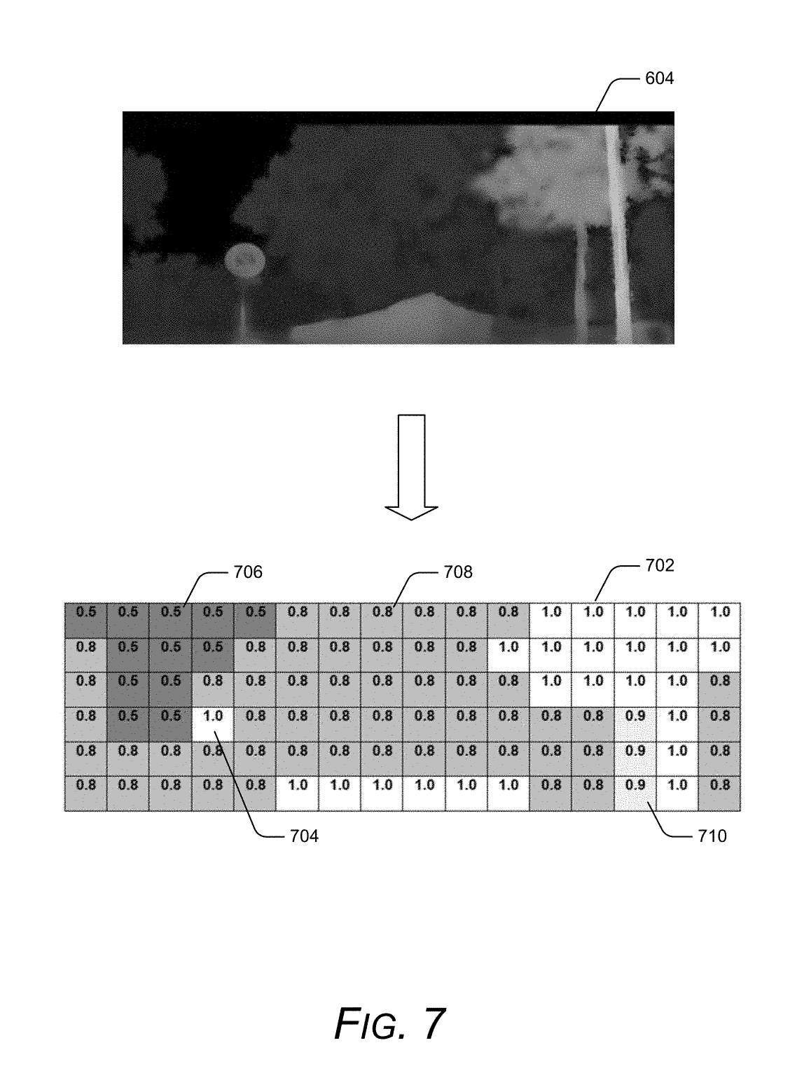

Once the camera generates a depth map, various embodiments dynamically generate weightings used calculate a current frame luma, and subsequently configure exposure metering by making adjustments to various exposure settings of image sensors (e.g., exposure time settings, luminance gain settings). Consider FIG. 7 that includes depth map 604 from FIG. 6, and weighting grid 702. In this example, a camera (or other computing device) dynamically generates weighting grid 702 based upon depth map 604. To do this, the camera first identifies or partitions the depth map into multiple regions, grid elements, or units, where a respective region, grid element, or unit has a corresponding grid element in weighting grid 702. The camera then categorizes each respective region in the depth map into one of multiple levels based upon distance and/or depth information. Each respective region can have a 1:1 relationship with a respective pixel of an image sensor, or can have a 1:N relationship, where a respective region corresponds to N pixels (N being an arbitrary number) and/or a grid of pixels as further described herein. In this example, the camera categorizes a respective region into one of three levels or classifications: foreground, intermediate, and background. However, any other suitable number of depth levels can be used without departing from the scope of the claimed subject matter.

Using the three levels of categorization, when a depth value is categorized as being foreground, the camera assigns a corresponding element in weighting grid 702 a value of 1.0. Applying this to sign 608-2 of FIG. 6, the camera then assigns weighting grid element 704 a value of 1.0, since weighting grid element 704 corresponds to either a pixel or a grid of pixels that have captured sign 608-2. In a similar manner, the camera assigns a value of 0.5 to elements corresponding to depth values considered background, and a weighting value of 0.8 to elements corresponding to depth values considered as intermediate. Accordingly, sky 610-2 of FIG. 6 corresponds to weighting grid element 706 and has a value of 0.5, while trees 612-2 of FIG. 6 corresponds to weighting grid element 708 has a value of 0.8. Thus, in this example, grid elements categorized as foreground have more weight and/or priority over grid elements categorized as intermediate and background. One advantage to dynamic weighting generation based upon depth map is the generation of a weighting grid that accounts for non-uniform shapes and depth included in a scene. For example, weighting grid element 706 and the various adjacent weighting grid elements considered as background form an asymmetrical and/or non-uniform shape that more closely matches the shape and size of sky 610-1 of FIG. 6 than a rectangular shape used in spot-weighting exposure metering or center-weighted exposure metering. In turn, this can improve exposure metering for a subsequent image capture and provide a better image quality, such as by having more “uniform exposure” in which each region of the subsequent image capture visually appears to be evenly exposed. Thus, in some embodiments, a weighting table can have adjacent grid elements (e.g., adjacent grid elements with a same weighting value) that form asymmetrical shapes, versus the symmetrical shapes utilized in fixed weighting tables. While a spot in fixed weighting tables can move from the center of a weighting grid (such as illustrated in table 504 or table 506 of FIG. 5) to center on an ROI associated with the sky, the fixed size and shape of the spot may not adequately account for all of the corresponding sky background. In turn, the resultant current frame luma calculation may result in improper or inadequate exposure metering. As another example, consider foreground object sign 608-2 of FIG. 6 object surrounded by background and intermediate scene objects (further illustrated by depth map 604). Without weighting grid generation based upon a depth map, the resultant exposure metering based upon one of the various fixed weighting tables may also result a degraded image. Conversely, weighting grid 702 applies a higher priority weighting to sign 608-2, thus ensuring an exposure metering that generates a better quality image capture. Accordingly, weighting grids associated with a depth map can dynamically change based upon the different objects within a scene or frame. In turn, exposure metering based upon object size and shape, instead of a fixed region, can improve image quality by reducing underexposed and overexposed regions in the overall image capture.

As further described herein, a grid element sometimes corresponds to multiple pixels and/or a grid of pixels. In turn, each respective pixel can have its own depth value. When a grid element corresponds to multiple pixels, each pixel may generate a respective depth value, thus producing multiple depth values for a respective weighting grid element. In such a case, the multiple depth values and/or multiple weighting values can be interpolated to generate a resultant weighting value. Consider weighting grid element 710 that has an assigned weighting value of 0.9. Assume for this example that the corresponding depth map for weighting grid element 710 has two depth values: a first depth value that is classified as a foreground value (with a weighting of 1.0) and a second depth value that is classified as an intermediate depth value (with a weighting of 0.8). Here, the camera generates the subsequent weighing value of 0.9 by interpolating the two weighting values, and assigns weighting grid element 710 the subsequent (interpolated) value. Thus, a weighting grid can include interpolated weighting values.

While weighting grid 702 represents a weighting grid in which foreground objects are given a higher weighting or priority than background objects, other priority assignments can be used. For example, in some cases, a weighting grid based off a depth map assigns a higher priority to background objects relative to foreground objects, or assign intermediate objects a higher priority than foreground and background objects. In some cases, a camera has default weighting priorities, such as foreground objects having a higher priority than background objects, that a user can subsequently change through a User Interface (UI). Alternately or additionally, a user can define a ROI to have a higher priority, where the user identifies a center position for the ROI, and a depth map is used to dynamically identify a size and shape of the ROI. Accordingly, the camera can assign weighting values based upon default priority information or obtain priority information from the user. Some embodiments base priority information on object size, such as by assigning a higher priority and/or weighting to larger objects and decreasing the weighting as object sizes get smaller, or assigning a higher weighting and/or priority to smaller objects than larger objects. Thus, various embodiments allow for dynamic configuration of priority assignments and/or weighting values.

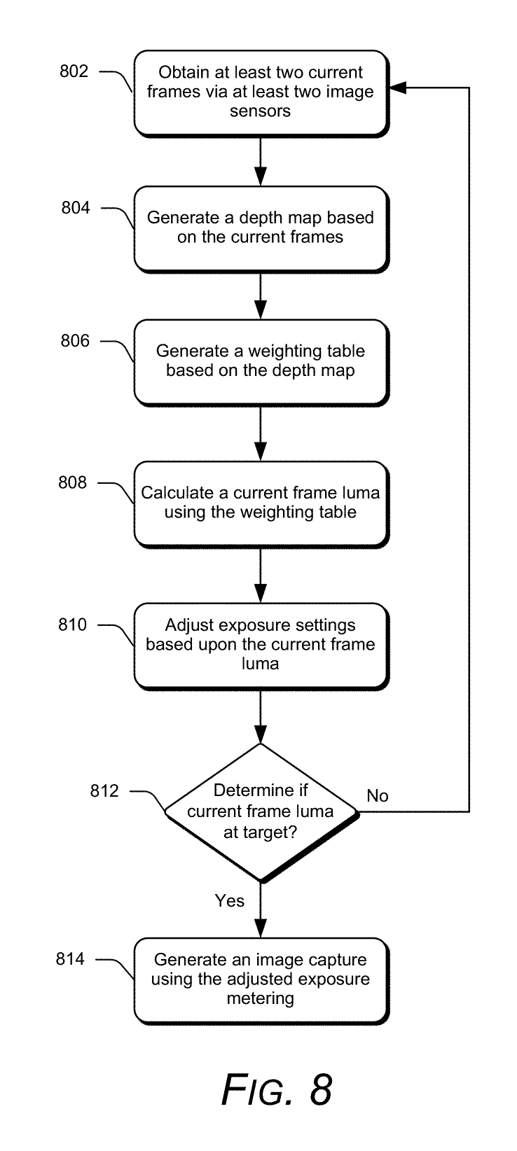

Consider FIG. 8 that illustrates a method of dynamic exposure metering based upon a depth map in accordance with one or more embodiments. The method can be performed by any suitable hardware, software, firmware, or combination thereof. In at least some embodiments, aspects of the method can be implemented by one or more suitably configured hardware components and/or software modules, such one or more components included in image capture module 104 of FIG. 1.

Step 802 obtains at least two current frames via at least two image sensors. This can include obtaining statistics from the at least two image sensors, such as Bayer Grid statistical information. In some cases, when an image sensor has multiple smaller sensors, each smaller sensor generates a corresponding statistic. Obtaining the current frames sometimes includes obtaining multiple image captures of a scene, where each respective current frame originates from a respective image sensor.

Responsive to obtaining the current frames, step 804 generates a depth map based on the current frames. Here, the depth map includes relational information about objects, points, or locations within the current frames, such as distance information. For example, to generate the depth map, some embodiments utilize at least two synchronized images of a same scene to discern distance information, as further described herein. However, alternate forms of relational information can be generated as well.

Step 806 generates a weighting table based on the depth map or other relational information. For instance, a camera can have a predetermined number of levels used to assign weightings, such as a predetermined number of distance classifications (e.g., foreground, intermediate, background). Any suitable number of levels can be utilized. In turn, the camera analyzes and categorizes the depth map distances that correspond to respective regions and/or pixels of the current frame into one of the levels, and then assigns the respective grid element of the weighting table a weighting value. A grid element can correspond to a single pixel or multiple pixels. When a grid element corresponds to multiple pixels, some embodiments interpolate the weighting value assigned to the grid element as further described herein. The weighting values that are assigned to the respective levels can be determined using default priority information, or user-defined priority information (e.g., ROI information, object information, foreground or background selection, etc.).

Step 808 calculates a current frame luma based upon the weighting table. For instance, some embodiments apply the values in the weighting table to respective statistical information generated by image sensors. Responsive to calculating the current frame luma, step 810 adjusts exposure settings associated with the image sensors, such as exposure time settings and/or luminance gain settings.

Step 812 determines if the current frame luma is at a predefined target luma value, or close enough to the target luma value. Some embodiments determine that the current frame luma is close enough to the predefined target luma if it falls within an acceptable tolerance to the predefine target luma. In some cases, a camera or computing device determines the difference between the current frame luma and the predefined luma target as a way to identify how to reconfigure the sensor hardware. Reconfiguring the sensor hardware can include modifying and/or reconfiguring exposure time and luminance gains to achieve a desired sensitivity to brightness based upon this difference. If the current frame luma fails to be at or close enough to the predefined target luma, the method proceeds to step 802 and repeats steps 802-812 in order to readjust the exposure settings to, in turn, generate a current frame luma that is within the predefined tolerance. If the current frame luma is considered to be at, or close enough to, the predefined target luma, the method proceeds to step 814.

Step 814 generates an image capture using the adjusted exposure settings that impact the camera's exposure metering (e.g., exposure time settings, luminance gain settings). This can occur automatically after the final adjustments to the exposure metering occurs, or can occur after receiving user input to generate the image capture.

While the method described in FIG. 8 illustrates these steps in a particular order, it is to be appreciated that any specific order or hierarchy of the steps described here is used to illustrate an example of a sample approach. Other approaches may be used that rearrange the ordering of these steps. Thus, the order steps described here may be rearranged, and the illustrated ordering of these steps is not intended to be limiting.

Having considered a discussion of a dynamic exposure metering based upon a depth map, consider now a discussion of empirical data generated in accordance with various embodiments described herein.

Empirical Test Data

Fixed weighting tables used in exposure metering oftentimes fails to adjust the exposure metering based upon real-world objects and lighting in a particular scene or frame. In turn, this can produce image captures with poor quality with partial regions of the image being underexposed or overexposed. Conversely, exposure metering based upon a depth map accounts for the sizes, shapes, and locations (e.g., depth) of the various object. In turn, depth map-based exposure metering improves the image quality of an image capture relative to those generated with fixed weighting exposure metering. To test the difference in image quality between fixed weighting AEC and depth map-based AEC, a camera captured a same scene using different exposure metering algorithms: first using fixed weighting exposure metering, then using dynamic exposure metering based upon a depth map.

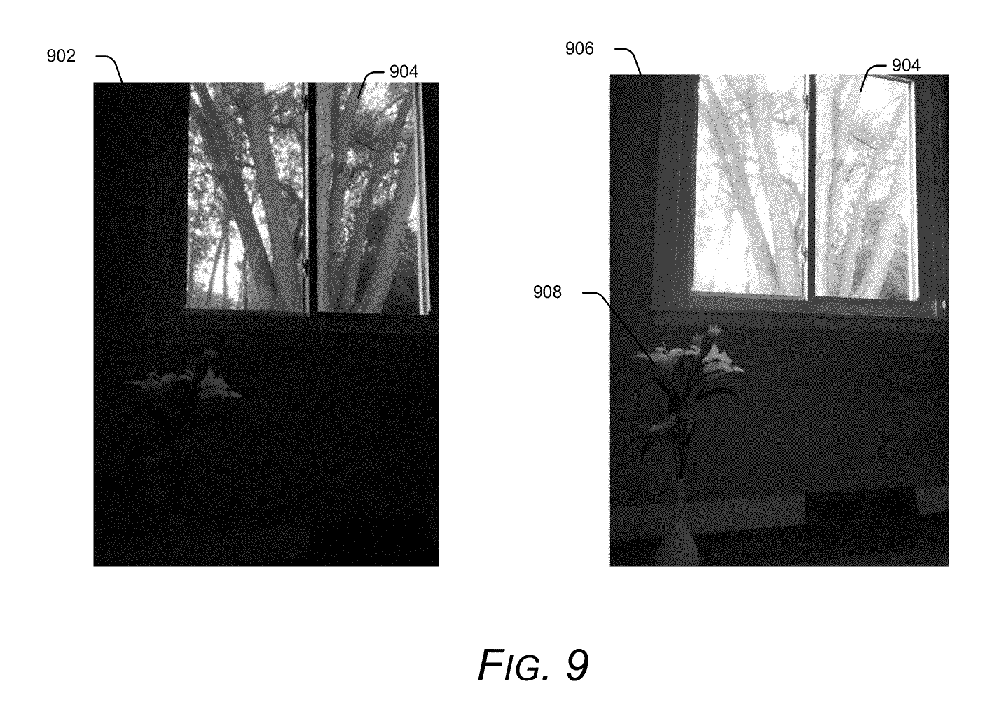

FIG. 9 illustrates the visual differences between image captures of a room using varying exposure metering processes that adjust exposure time and/or luminance gain. In this test case, the luminance of the room is considered backlit, where lighting is situated in the background and moving towards the foreground. This type of lighting configuration can cause issues in fixed weighting exposure metering that results in uneven exposure within a captured image (e.g., overexposed or underexposed regions within the captured image). Consider image 902, which displays an image capture generated with a fixed weighting exposure metering process. Here, outdoor window 904 acts as a source of illumination. With fixed weighting tables, outdoor window 904 dominates in the current frame luma calculation used to set exposure time and/or luminance gain and, as such, causes other regions within the resultant image capture to be underexposed. For instance, consider the lower left region of image 902 that is underexposed. While region includes a flower vase, the flower vase is obscured and difficult to see due to the current exposure metering.

Now consider image 906 that displays an image capture generated with dynamic weighting generation based upon depth map as further described herein. Similar to that of image 902, outdoor window 904 is positioned in the background, causing the same backlight condition. However, since the exposure metering is weighted and based upon objects and/or distances included in the scene, flower vase 908 is no longer obscured. Instead, the settings applied for the exposure metering provides enough exposure to the corresponding region to make flower vase 908 visible, as well as other details about the room that were previously obscured. In this example, the weighting priority assigns higher priority to foreground objects and results in an image capture with less underexposed regions. Thus, in terms of clearly capturing objects within a scene, image 906 with dynamic weighting generation based upon a depth map provides an improved image over image 902.

Having considered a discussion of an example test case that employed dynamic exposure metering based upon a depth map, consider now a discussion of an example device which can include dynamic exposure metering based upon a depth map in accordance with various embodiments described herein.

Example Device

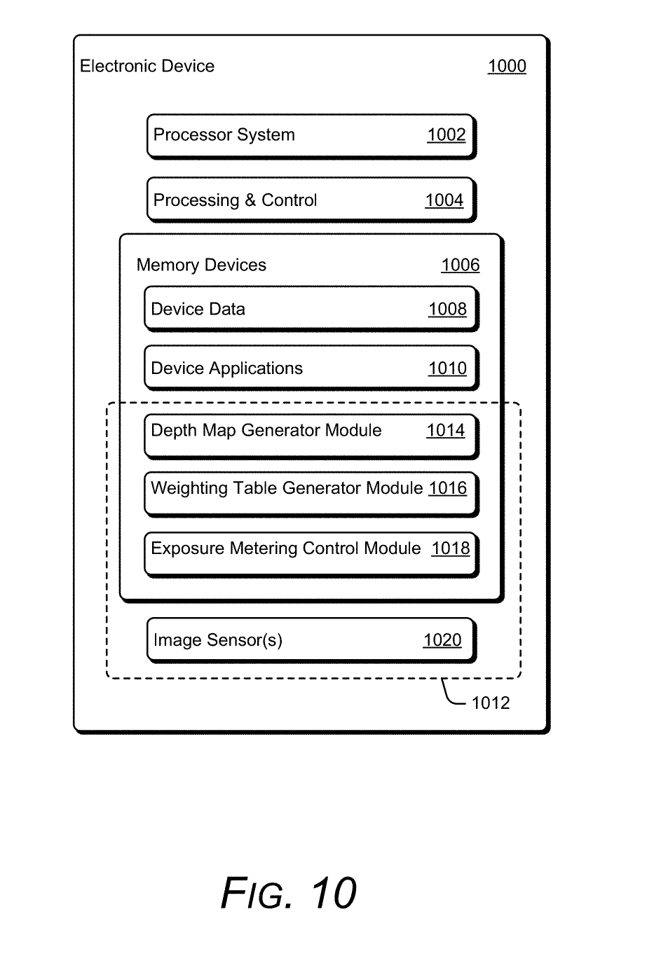

FIG. 10 illustrates various components of an example electronic device 1000 that can be utilized to implement the embodiments described herein. Electronic device 1000 can be, or include, many different types of devices capable of implementing dynamic exposure metering based upon a depth map, such as depth map generator module 108, weighting table generator module 110, and/or exposure metering control module 112 of FIG. 1.

Electronic device 1000 includes processor system 1002 (e.g., any of application processors, microprocessors, digital-signal processors, controllers, and the like) or a processor and memory system (e.g., implemented in a system-on-chip), which processes computer-executable instructions to control operation of the device. A processing system may be implemented at least partially in hardware, which can include components of an integrated circuit or on-chip system, digital-signal processor, application-specific integrated circuit, field-programmable gate array, a complex programmable logic device, and other implementations in silicon and other hardware. Alternately or in addition, the electronic device can be implemented with any one or combination of software, hardware, firmware, or fixed-logic circuitry that is implemented in connection with processing and control circuits, which are generally identified as processing and control 1004. Although not shown, electronic device 1000 can include a system bus, crossbar, interlink, or data-transfer system that couples the various components within the device. A system bus can include any one or combination of different bus structures, such as a memory bus or memory controller, data protocol/format converter, a peripheral bus, a universal serial bus, a processor bus, or local bus that utilizes any of a variety of bus architectures.

Electronic device 1000 also includes one or more memory devices 1006 that enable data storage, examples of which include random access memory (RAM), non-volatile memory (e.g., read-only memory (ROM), flash memory, EPROM, EEPROM, etc.), and a disk storage device. Memory devices 1006 are implemented at least in part as a physical device that stores information (e.g., digital or analog values) in storage media, which does not include propagating signals or waveforms. The storage media may be implemented as any suitable types of media such as electronic, magnetic, optic, mechanical, quantum, atomic, and so on. Memory devices 1006 provide data storage mechanisms to store the device data 1008 and other types of information or data. In some embodiments, device data 1008 includes digital images. Memory devices 1006 also provide storage for various device applications 1010 that can be maintained as software instructions within memory devices 1006 and executed by processor system 1002.

To facilitate image capture, electronic device 1000 includes image capture module 1012. Here, portions of image capture module 1012 reside on memory devices 1006: depth map generator module 1014, weighting table generator module 1016, and exposure metering control module 1018, while other portions of image capture module 1012 are implement in hardware: image sensors 1020. While illustrated here as residing on memory devices 1006, alternate embodiments implement depth map generator module 1014, weighting table generator module 1016, and/or exposure metering control module 1018 using varying combinations of firmware, software, and/or hardware

Among other things, depth map generator module 1014 generates relational information about objects in a scene, such as a depth map, by using captured digital images or frame information about a scene that is in view of image sensors 1020. Weighting table generator module 1016 dynamically generates a weighting table used to adjust exposure settings, such as exposure time and luminance gain settings associated with image sensors 1020. Exposure metering control module 1018 adjusts exposure metering associated with image sensors 1020 based upon the weighting table generated by weighting table generator module 1016. In some embodiments, adjusting the exposure metering includes adjustments to exposure time and/or luminance gain settings associated with image sensors 1020.

Image sensor(s) 1020 represent functionality that digitally captures scenes. In some embodiments, each image sensor included in electronic device 1000 captures information about a scene that is different from the other image sensors, as further described above. For example, a first image sensor can capture a color image using Bayer techniques, and a second image sensor can capture clear images. The sensors can be individual sensors that generate an image capture, or include multiple smaller sensors that work in concert to generate an image capture.

It is to be appreciated that while electronic device 1000 includes distinct components, this is merely for illustrative purposes, and is not intended to be limiting. In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A computing device comprising:
at least two image sensors;
at least one processor; and
one or more computer-readable storage devices comprising processor executable instructions that, responsive to execution by the at least one processor, implement:
a depth map generator module for receiving a current frame generated by the at least two image sensors and generating a depth map based on the current frame;
a weighting table generator module for obtaining the depth map from the depth map generator module and generating a weighting table based on the depth map; and
an exposure metering control module for obtaining statistical information from the at least two image sensors, applying the weighting table to the statistical information to determine a current frame luma, and adjusting an exposure metering of the computing device based on the current frame luma to configure image captures performed by the at least two image sensors.

2. The computing device as recited in claim 1, wherein generating the weighting table further comprises:
partitioning the depth map into multiple regions;
categorizing each respective region of the multiple regions into a respective level of multiple levels; and
assigning, in a respective grid element of the weighting table, the respective region a weighting value associated with the respective level.

3. The computing device as recited in claim 2, wherein assigning the respective region the weighting value further comprises:
obtaining priority information via a User Interface (UI); and
assigning the weighting value based on the priority information.

4. The computing device as recited in claim 3, wherein obtaining priority information further comprises obtaining a Region-of-Interest (ROI).

5. The computing device as recited in claim 2, wherein assigning the respective region the weighting value further comprises generating the weighting value by interpolating multiple weighting values.

6. The computing device as recited in claim 2, wherein assigning the respective region the weighting value further comprises applying default weighting priorities that have foreground objects at a higher priority than background objects.

7. The computing device as recited in claim 2, wherein assigning the respective region the weighting value further comprises applying higher weighting priorities to background objects relative to weighting priorities applied to foreground objects.

8. The computing device as recited in claim 1, wherein the weighting table comprises adjacent grid elements with an asymmetrical shape.

9. A method comprising:
generating, using a computing device, a depth map from a current frame obtained via two image sensors associated with the computing device;
dynamically generating, using the computing device, a weighting table based on the depth map;
calculating, using the computing device, a current frame luma based on the weighting table; and
adjusting, using the computing device, an exposure metering associated with the two image sensors based on the current frame luma to modify subsequent image captures performed by the two image sensors.

10. The method as recited in claim 9, wherein dynamically generating the weighting table further comprises:
partitioning the depth map into multiple regions; and
assigning a respective weighting value to each respective region of the multiple regions based on a respective depth value of the respective region.

11. The method as recited in claim 10, wherein partitioning the depth map into multiple regions further comprises:
partitioning each respective region of the multiple regions to correspond to a respective grid of pixels.

12. The method as recited in claim 11, wherein each respective grid of pixels comprises a grid of 34×48 pixels.

13. The method as recited in claim 10, wherein dynamically generating the weighting table further comprises:
for at least one respective region of the multiple regions, interpolating multiple weighting values to generate the respective weighting value for the at least one respective region.

14. The method as recited in 9, further comprising:
comparing the current frame luma to a target luma;
determining whether the current frame luma is within a predefined tolerance of the target luma; and
responsive to determining the current frame luma is not within the predefined tolerance of the target luma, repeating the generating the depth map, the dynamically generating the weighting table, the calculating the current frame luma, and the adjusting the exposure metering until the current frame luma is within a predefined tolerance of the target luma.

15. The method as recited in claim 9, wherein dynamically generating the weighting table further comprises:
assigning a higher weighting value to grid elements in the weighting table that correspond to objects identified in the depth map that are larger than other objects identified in the depth map.

16. The method as recited in claim 9, wherein calculating the current frame luma further comprises using Bayer grid statistical information for a grid of pixels.

17. A camera comprising:
two image sensors;
at least one processor; and
one or more computer-readable storage devices comprising processor executable instructions that, responsive to execution by the at least one processor, work in concert with the at least two image sensors to enable the camera to perform operations comprising:
generating a depth map from a current frame associated with a scene in view of the two image sensors;
dynamically generating a weighting table based on the depth map;
calculating a current frame luma based on the weighting table;
adjusting an exposure metering associated with the two image sensors based on the current frame luma to modify subsequent image captures performed by the two image sensors;
comparing the current frame luma to a target luma;
determining whether the current frame luma is within a predefined tolerance of the target luma; and
responsive to determining the current frame luma is not within the predefined tolerance of the target luma, readjusting the exposure metering until the current frame luma is within a predefined tolerance of the target luma.

18. The camera as recited in claim 17, wherein readjusting the exposure metering further comprises repeating the generating the depth map, the dynamically generating the weighting table, the calculating the current frame luma, the adjusting the exposure, and the comparing the current frame luma to the target luma until the current frame luma is within the predefined tolerance.

19. The camera as recited in claim 17, wherein dynamically generating the weighting table further comprises:
assigning weighting values in the weighting table based on priority information, the priority information comprising:
default priority information that assigns foreground objects identified by the depth map at a higher priority than background objects identified by the depth map; or
user-defined priority information.

20. The camera as recited in claim 19, wherein:
the user-defined priority information comprises a Region-of-Interest (ROI), and
assigning weighting values in the weighting table further comprises dynamically identifying a size and shape of the ROI.
